(19) United States
(12) Patent Application Publication
(10) Pub. No.: US 2012/0168400 A1
(43) Pub. Date: Jul. 5, 2012

(54) Capped beverage container having an open chamber storing a sealed tube of other beverage

(75) Inventor: Sheng-Ming Wang, Tarpon Springs, FL (US)

(73) Assignee: SHENG-MING WANG, TARPON SPRINGS, FL (US)

(21) Appl. No.: 12/930,145

(22) Filed: Dec. 30, 2010

(51) Int. Cl. B65D 41/04; B65D 90/02; B67B 3/00

(52) U.S. Cl. 215/329; 53/471; 215/379

(57) ABSTRACT

A beverage container made of plastic by blow molding process has three chambers all along a same axis—an upper conical chamber with a removable cap to contain carbon dioxide gas (but not limited to), a lower outer cylindrical chamber, connected to the upper conical chamber, to contain a carbonated drink (but not limited to), and an inner cylindrical open chamber, smaller in diameter & height than the lower outer cylindrical chamber and isolated from the two other chambers, to store a sealed cylindrical tube containing a pasteurized drink (but not limited to). A liquid ratio of the carbonated drink to the pasteurized drink is the ratio of an optimum mixture of the two beverages into a certain desired cocktail punch.

At the time of bottling, the sealed cylindrical tube containing the pasteurized drink will be inserted into the frictionally fitted inner cylindrical open chamber, then the other two chambers will be filled with the carbon dioxide and the carbonated drink accordingly and capped. At the time of transportation & store display, the gas pressure in the container pressed onto the enclosure of the inner cylindrical open chamber will firmly grab the sealed cylindrical tube in place. At the time of consumption, uncap the container to release gas, pull out the sealed cylindrical tube from the inner cylindrical open chamber, remove the seal of the sealed cylindrical tube, and pour the pasteurized drink into the upper conical chamber. This process will mix the carbonated drink with the pasteurized drink to produce the certain desired cocktail punch.

### BACKGROUND OF THE INVENTION

There are three main types of bottled beverages by the ways of preservation—1) drinks containing fruit juices, teas, etc. with preservatives; 2) drinks containing fruit juices, teas, etc., pasteurized; and 3) carbonated soft drinks using carbon dioxide and low PH to prevent bacteria growth. It is popular in any birthday, prom, etc. parties to offer some custom-blend “cocktail punch” by blending different kind of carbonated soft drinks, flavored drinks, fruit juices, fresh ingredients, and ice together in proportion in a serving container. It is a time consuming process in preparing & making such a cocktail punch, and it requires knowledge to blend optimum mixture of all ingredients in right proportion to have a tasty drink. In the present beverage industry there were no premixed cocktail punches in the same container containing major portion of carbonated soft drinks with smaller portion of pasteurized or preservatives-added drinks. The reason for that is the mixture of carbonated soft drinks with pasteurized or preservatives-added drinks for an extended time (shelf time) would cause certain bacteria growth (yeast and certain lactic acid bacteria) existed in the carbonated beverage with the nutrients of sugar in the pasteurized beverage, and the bacteria growth results in the production of spoilage, haze, sediment, off-flavors, and gas.

Multi-chamber bottles are already on the market and used as vessels for multi-components with multi closures. Some patents such as U.S. Pat. No. 6,550,647, U.S. Pat. No. 5,765,725, U.S. Pat. No. 6,626,308, U.S. Design Pat. No. D509,754, and U.S. Design Pat. No. D495,949 have multi-chambers of equal size positioned side by side with one closure. But none of the containers have multi-cylindrical chambers along a same axis, capable of containing both carbonated beverage and pasteurized beverage.

### FIELD OF THE INVENTION

The present invention relates to a beverage container having three chambers along a same axis—an upper conical chamber with a removable cap containing carbon dioxide gas only (but not limited to), a lower outer cylindrical chamber, connected to the upper conical chamber, containing a carbonated drink (but not limited to), and an isolated inner cylindrical open chamber storing a sealed cylindrical tube containing a pasteurized juice (but not limited to). At the time of bottling, the sealed cylindrical tube with the pasteurized juice is inserted into the inner cylindrical open chamber from the bottom of the beverage container. Following that the lower outer cylindrical chamber is filled with the carbonated drink and the upper conical chamber with the carbon dioxide gas and capped. At the time of consumption, uncap the pressurized beverage container to release gas, pull out the sealed cylindrical tube containing the pasteurized juice from the inner cylindrical open chamber, remove the seal of sealed cylindrical tube, pour the pasteurized juice into the upper conical chamber to mix with the carbonated drink in the lower outer cylindrical chamber, and produce a desired cocktail punch.

### SUMMARY OF THE INVENTION

A beverage container of the invention, which will be referred to as the container in the subsequent paragraphs, comprises an upper orifice threaded for receiving a removable cap, an upper conical sidewall, a lower outer cylindrical sidewall, a curved top connecting the upper conical sidewall and the lower outer cylindrical sidewall, a donut bottom, an inner cylindrical sidewall, and a closed top of the inner cylindrical sidewall. The inner cylindrical sidewall has a plural of concaved ribs, concaved inwardly to a depth, extended the whole height of the inner cylindrical sidewall, and spaced evenly along the circumference of the inner cylindrical sidewall. All the upper conical sidewall, the lower outer cylindrical sidewall, and the inner cylindrical sidewall have a same axis, but different in diameter, height, and shape.

The donut bottom of the container shaped as a donut has an outer curved wall forming a larger circle coincided and joined with the lower outer cylindrical sidewall, and an inner curved wall forming a smaller circle coincided and joined with the inner cylindrical sidewall.

The container has three chambers—an upper conical chamber, a lower outer cylindrical chamber connected to the upper conical chamber, and an isolated inner cylindrical open chamber. In accord with the invention, the contents of the three chambers are a carbonated drink (but not limited to) in the lower outer cylindrical chamber, carbon dioxide gas (but not limited to) in the upper conical chamber, and storing a sealed cylindrical tube containing a pasteurized juice (but not limited to) in the inner cylindrical open chamber.

The upper conical chamber contains a volume formed by the upper orifice and the upper conical sidewall. The lower outer cylindrical chamber contains a volume formed by the curved top, the lower outer cylindrical sidewall, the donut bottom, the inner cylindrical sidewall, and the closed top of the inner cylindrical sidewall. The inner cylindrical open chamber contains a volume formed by the inner cylindrical sidewall, the closed top, and the inner curved wall of the donut bottom. Further defined, the volume of the upper conical chamber is slightly larger than the volume of the inner cylindrical open chamber. The volume ratio of the lower outer cylindrical chamber to the inner cylindrical open chamber is determined by the liquid ratio of the carbonated drink to the pasteurized juice in a desired cocktail punch.

The sealed cylindrical tube to be inserted into the inner cylindrical open chamber comprises a tubular sidewall, a ring of concave near the base of the tubular sidewall, a bottom, a slanted top, and a thickened ring of top open end receiving an adhesive seal of paper or aluminum foil. The diameter of the tubular sidewall is the diameter of the inner cylindrical sidewall deducts the depth of concave of the plural of concaved ribs.

At the time of bottling, the sealed cylindrical tube is inserted into the inner cylindrical open chamber prior to the filling of the two other chambers, and the depth of concave of the plural concaved ribs of the inner cylindrical sidewall being depressed to 50% in depth will hold by friction the sealed cylindrical tube in the inner cylindrical open chamber. Later when the lower outer cylindrical chamber is filled with the carbonated drink and the upper conical chamber with the carbon dioxide gas and capped, the pressure of gas pressed onto the plural concaved ribs of the inner cylindrical sidewall will produce further firm grabbing of the sealed cylindrical tube during transportation. At the time of consumption, the pasteurized juice in the sealed cylindrical tube is poured into the upper conical chamber and mixed with the carbonated drink in the lower outer cylindrical chamber to produce an optimum mixture of the two beverages making the certain desired cocktail punch.

The container is made of plastic by blow molding process used for plastic bottles, but it can be made of composites as well. And the inner cylindrical open chamber is created in one blow molding process with the upper conical chamber and the lower outer cylindrical chamber. The making of the container, filling of beverage, gas, and capping are the same methods as commonly used in the carbonated drinks industry. The sealed cylindrical tube is also made of plastic by blow molding process used for plastic containers, but it can be made of composites as well. The making of the cylindrical tube, filling of beverage, and sealing are the same methods as commonly used in the pasteurized drinks industry.

### BRIEF DESCRIPTION OF THE DRAWING

FIG. 1—is a center line vertical cross section of an empty container with three chambers in accordance with an embodiment of the present invention through an axis along the line of 1-1 of FIG. 3.

FIG. 2—is a horizontal cross section of the empty container of FIG. 1 along the line 2-2 of FIG. 1.

FIG. 3—is a horizontal cross section of the empty container of FIG. 1 along the line 3-3 of FIG. 1.

FIG. 4—is a center line vertical cross section of a sealed cylindrical tube filled with a beverage in accordance with an embodiment of the present invention.

FIG. 5—is a top view of the sealed cylindrical tube of FIG. 4.

FIG. 6—is a center line cross section through the same axis of FIG. 1 showing the container of FIG. 1 filled with beverage, gas, and capped and the sealed cylindrical tube of FIG. 4 being inserted into the container.

FIG. 7—is an exterior elevation of the container of the FIG. 1.

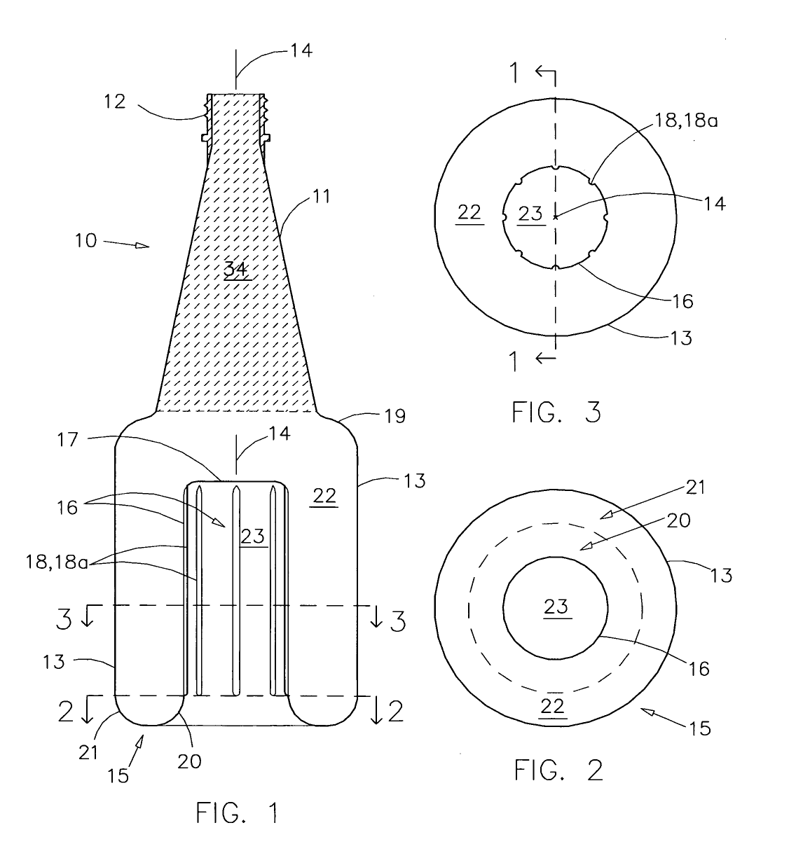

### DETAILED DESCRIPTION OF THE PREFERRED EMBODIMENT

FIG. 1 is shown a preferred embodiment of a beverage container 10 comprises an upper orifice 12, threaded for receiving a removable cap 33 (not shown), an upper conical sidewall 11, lying along a longitudinal axis 14, a lower outer cylindrical sidewall 13, lying along the axis 14, a curved top 19, connecting the upper conical sidewall 11, with the lower outer cylindrical sidewall 13, a donut bottom 15, an inner cylindrical sidewall 16, lying along the same axis 14, and a closed top 17, of the inner cylindrical sidewall 16.

FIGS. 1 & 2 are shown the donut bottom 15, of the container 10, shaped as a donut has an inner curved wall 20, forming a smaller circle, coincided and joined with the inner cylindrical sidewall 16, and an outer curved wall 21, forming a larger circle, coincided and joined with the lower outer cylindrical sidewall 13.

FIGS. 1 & 3 are shown the inner cylindrical sidewall 16, has a plural of concaved ribs 18, concaved inwardly toward the axis 14, to a depth 18a, extended the whole height of the inner cylindrical sidewall 16, and spaced evenly along the circumference of the inner cylindrical sidewall 16. FIGS. 1 & 3 further shown the container 10 has three chambers—an upper conical chamber 34 (hatched area), a lower outer cylindrical chamber 22, connected to the upper conical chamber, and an isolated inner cylindrical open chamber 23. The upper conical chamber 34 contains a volume formed by the upper orifice 12, and the upper conical sidewall 11. The lower outer cylindrical chamber 22 contains a volume formed by the curved top 19, the lower outer cylindrical sidewall 13, the donut bottom 15, the inner cylindrical sidewall 16, and the closed top 17. The inner cylindrical open chamber 23 contains a volume formed by the inner cylindrical sidewall 16, the closed top 17, and the inner curved wall 20.

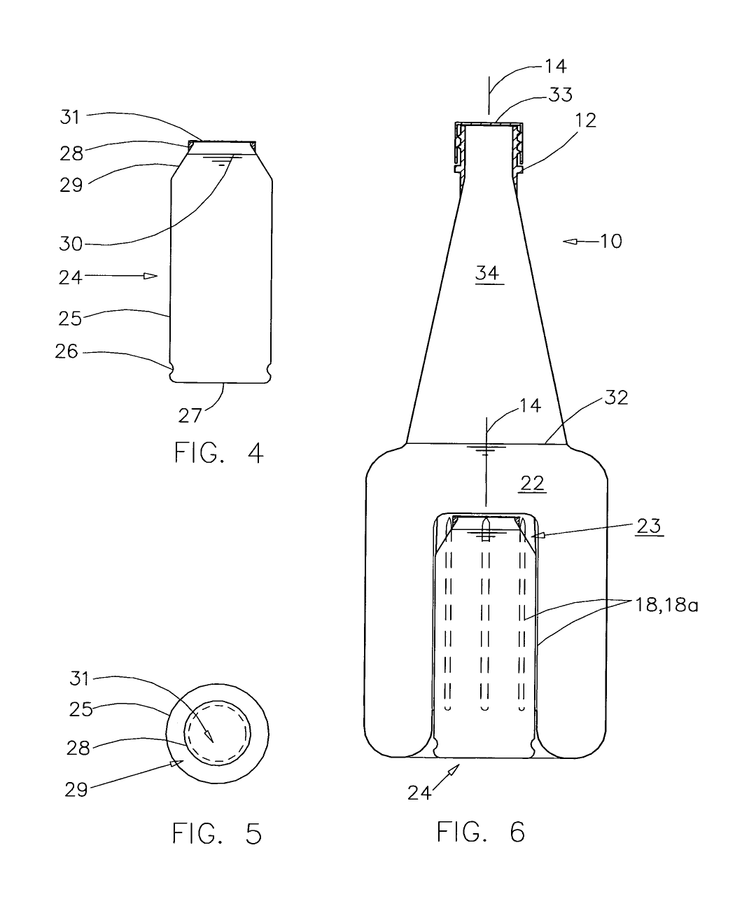

FIGS. 4 & 5 are shown a sealed cylindrical tube 24, comprises a tubular sidewall 25, a ring of concave 26, near the base of the tubular sidewall 25, a bottom 27, a slanted top 29, and a thickened ring of top open end 28. FIG. 4 further shown the sealed cylindrical tube 24 is filled with a pasteurized drink 30 (but not limited to), and received an adhesive seal of paper or aluminum foil 31, over the thickened ring of top open end 28.

FIGS. 3 & 4 are shown the diameter of the tubular sidewall 25 is the diameter of the inner cylindrical sidewall 16, deducting the depth of concave 18a, of the plural of concaved ribs 18.

FIG. 6 is shown the sealed cylindrical tube 24, is inserted into the inner cylindrical open chamber 23, and the upper conical chamber 34, is filled with carbon dioxide gas (not shown), and the lower outer cylindrical chamber 22, is filled with a carbonated drink 32, and receives a removable cap 33. And it further shows that the depth of concave 18a, of the plural of concaved ribs 18, has been depressed to 50% in depth by the sealed cylindrical tube 24.

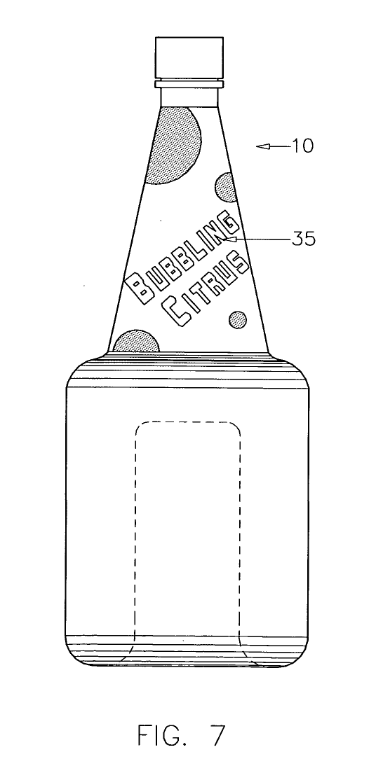

FIG. 7 is shown the exterior elevation of the container 10, receiving an advertising label 35, over the surface of the upper conical sidewall 11.

We claim:

1. A beverage container, made of plastic and produced by a blow molding process, comprises an upper orifice threaded for receiving a removable cap, an upper conical sidewall lying along a longitudinal axis, an lower outer cylindrical sidewall lying along the same longitudinal axis, a curved top joining the upper conical sidewall with the lower outer cylindrical sidewall, a donut bottom, an inner cylindrical sidewall also lying along the same longitudinal axis, and a closed top of the inner cylindrical sidewall.

2. The donut bottom of the claim 1 has an inner curved wall forming a smaller circle, coincided and joined with the inner cylindrical sidewall of the claim 1, and an outer curved wall forming a larger circle, coincided and joined with the lower outer cylindrical sidewall of the claim 1.

3. The inner cylindrical sidewall of claim 1 has a plural of concaved ribs spaced evenly along the circumference of the inner cylindrical sidewall of claim 1, concaved inwardly toward the axis of the claim 1, to a depth, and extended the whole height of the inner cylindrical sidewall of claim 1.

4. The container of the claim 1 has three chambers—an upper conical chamber with the removable cap of the claim 1, a lower outer cylindrical chamber connected to the upper conical chamber, and an isolated inner cylindrical open chamber.

5. The three chambers of the claim 4 are to be filled in the following steps and contents. Step 1, insert a sealed cylindrical tube containing a pasteurized drink (but not limited to) into the inner cylindrical open chamber. Step 2, fill a carbonated drink (but not limited to) into the lower outer cylindrical chamber and carbon dioxide gas (but not limited to) into the upper conical chamber. Step 3, cap the upper conical chamber.

6. A liquid ratio of the carbonated drink to the pasteurized drink of the claim 5 is the ratio of an optimum mixture of the two beverages into a certain desired cocktail punch.

7. The upper conical chamber of the claim 4 is formed by the upper orifice and the upper conical sidewall of the claim 1.

8. The lower outer cylindrical chamber of the claim 4 is formed by the curved top, the lower outer cylindrical sidewall, the donut bottom, the inner cylindrical sidewall, and the closed top of the inner cylindrical sidewall of the claim 1.

9. The inner cylindrical open chamber of the claim 4 is formed by the inner cylindrical sidewall and the closed top of the inner cylindrical sidewall of the claim 1, and the inner curved wall of the donut bottom of the claim 2.

10. The sealed cylindrical tube of the claim 5, made of plastic and produced by a blow molding process, comprises a tubular sidewall, a ring of concave near the base of the tubular sidewall, a bottom, a slanted top, and a thickened ring of top open end receiving an adhesive seal of paper or aluminum foil.

11. The diameter of the tubular sidewall of the claim 10 is the diameter of the inner cylindrical sidewall of the claim 1, deducts the depth of the concave of the plural of concaved ribs of the claim 3.

12. In the step 1 of the claim 5, the sealed cylindrical tube, inserted into the inner cylindrical open chamber of the claim 4, depresses the depth of concave of the plural of concaved ribs of the claim 3 to 50% in depth.

13. In the step 2 of the claim 5, the gas pressure of the carbon dioxide in the upper conical chamber and the lower cylindrical chamber of the claim 4, pressed onto the inner cylindrical sidewall of the claim 1, produces a firm grabbing of the sealed cylindrical tube in the step 1 of the claim 5.

14. The exterior surface of the upper conical sidewall of the claim 1 is to receive an advertising label.

15. At the time of consumption, uncap the container of the claim 1, pull out the sealed cylindrical tube of the claim 5 from the inner cylindrical open chamber of the claim 4, remove the paper or aluminum foil seal of the claim 10, and pour the pasteurized drink of the claim 5 into the upper conical chamber of the claim 4. This process produces the desired cocktail punch of the claim 6.
